(19) United States
(12) Patent Application Publication
(10) Pub. No.: US 2008/0059455 A1
(43) Pub. Date: Mar. 6, 2008

(54) METHOD AND APPARATUS OF OBTAINING OR PROVIDING SEARCH RESULTS USING USER-BASED BIASES

(76) Inventors: Michael-David N. CANOY, San Diego, CA (US); Charles Wheeler SWEET, San Diego, CA (US); Jeffrey Joseph VACCARO, Encinitas, CA (US)

Correspondence Address: QUALCOMM INCORPORATED, 5775 MOREHOUSE DR., SAN DIEGO, CA, 92121, US

(21) Appl. No.: 11/848,046

(22) Filed: Aug. 30, 2007

Related U.S. Application Data
(60) Provisional application No. 60/841,805, filed on Aug. 31, 2006.

(51) Int. Cl. G06F 17/30

(52) U.S. Cl. 707/5; 707/E17.014

(57) ABSTRACT

Methods, apparatus, processors, and computer program products for obtaining or providing search results are provided. A method of providing search results includes receiving a query initiated by a user and performing a search based on the query. The method further includes determining a friends bias associated with the user, biasing a search result based on the friends bias, and storing the biased search results. Further provided is a method for obtaining search results that includes receiving a query initiated by a user and forwarding the query for performance of a search. Further included in the method is receiving and storing a biased search result in response to the query. The biased search result is based on friends bias data.

### CLAIM OF PRIORITY UNDER 35 U.S.C. §119

The present Application for Patent claims priority to Provisional Application No. 60/841,805 entitled “METHOD AND APPARATUS FOR PROVIDING IMPROVED SEARCH RESULTS USING USER-BASED BIASES” filed Aug. 31, 2006, and assigned to the assignee hereof and hereby expressly incorporated by reference herein.

### BACKGROUND

1. Field

The subject disclosure relates generally to search engines. More specifically, aspects disclosed herein relate to providing targeted search results based on biases.

2. Background

A search engine is an information retrieval system designed to assist in finding information on a computer system. For example, a search engine can be used to find information on the World Wide Web, on the local memory of a computer, or in an application such as a contacts list. A query is submitted by a user to the search engine, and the search engine determines matches to the query within its associated computer system. For example, the search engine or another portion of the system may index the information within the respective computer system, and the data that comprises the query is compared to the indexed information to determine a match. Further, the search engine assembles the matching information as a search result. Additionally, the search engine can rank the matching information, such as based on a percentage of a match or on a popularity basis. Subsequently, the search engine returns the matched information to the user as a search result.

A search engine is designed to provide a general answer or response to the query of the user. As such, two different users submitting identical queries to the same search engine will receive back approximately the same search results.

As search engines become an ever indispensable part of modern life, there is a need to provide more targeted/refined search results to users.

### SUMMARY

The following presents a simplified summary of one or more aspects in order to provide a basic understanding of such aspects. The subject summary is not an extensive overview of all contemplated aspects, and is intended to neither identify key or critical elements of all aspects nor delineate the scope of any or all aspects. The sole purpose of the subject summary is to present some concepts of one or more aspects in a simplified form as a prelude to the more detailed description that is presented later.

In an aspect, a method of providing search results comprises receiving a query initiated by a user and performing a search based on the query. The method further includes determining a friends bias associated with the user, and biasing a search result based on the friends bias. Additionally, the method includes storing the biased search result.

In another aspect, a computer program product configured to provide search results comprises a computer readable medium. The computer readable medium comprises at least one instruction for causing a computer to receive a query initiated by a user, and at least one instruction for causing the computer to perform a search based on the query. Further, the computer readable medium comprises at least one instruction for causing the computer to determine a friends bias associated with the user, and at least one instruction for causing the computer to bias a search result based on the friends bias. Additionally, the computer readable medium comprises at least one instruction for causing the computer to store the biased search result.

In a further aspect, at least one processor configured to provide search results comprises a first module for receiving a query initiated by a user and a second module for performing a search based on the query. Further, the at least one processor includes a third module for determining a friends bias associated with the user, and a fourth module for biasing a search result based on the friends bias. Additionally, the at least one processor includes a fifth module for storing the biased search result.

In yet another aspect, an apparatus for providing search results comprises means for receiving a query initiated by a user and means for performing a search based on the query. Further, the apparatus comprises means for determining a friends bias associated with the user, and means for biasing a search result based on the friends bias. Additionally, the apparatus comprises means for storing the biased search result.

In still further aspects, an apparatus for providing search results comprises a communications component operable to receive a query initiated by a user, and a search engine component operable to perform a search and generate a search result based on the query. The apparatus further comprises a friends bias component comprising friends bias data associated with the user, wherein the search engine component or the friends bias component is further operable to generate a biased search result corresponding to a biasing of the search result based on the friends bias data. Additionally, the apparatus comprises a storage component operable to store the biased search result.

In yet another aspect, a method for obtaining search results comprises receiving a query initiated by a user and forwarding the query for performance of a search. Further, the method comprises receiving and storing a biased search result in response to the query, wherein the biased search result is based on friends bias data.

In still another aspect, a computer program product configured to obtain search results comprises a computer readable medium. The computer readable medium comprises at least one instruction for causing a computer to receive a query initiated by a user, and at least one instruction for causing the computer to forward the query for performance of a search. Additionally, the computer readable medium comprises at least one instruction for causing the computer to receive and store a biased search result in response to the query, wherein the biased search result is based on friends bias data.

In a further aspect, at least one processor configured to obtain search results comprises a first module for receiving a query initiated by a user and a second module for forwarding the query for performance of a search. Additionally, the at least one processor comprises a third module for receiving and storing a biased search result in response to the query, wherein the biased search result is based on friends bias data.

In yet another aspect, an apparatus for obtaining search results comprises means for receiving a query initiated by a user, and means for forwarding the query for performance of a search. Additionally, the apparatus comprises means for receiving and means for storing a biased search result in response to the query, wherein the biased search result is based on friends bias data.

In a further aspect, an apparatus for obtaining search results comprises a search initiator component operable to receive a query initiated by a user, and a communications component operable to forward the query for performance of a search. Additionally, the apparatus comprises a search result review component operable to receive and store a biased search result in response to the query, wherein the biased search result is based on friends bias data.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a schematic diagram of an aspect of a system operable to provide or obtain a friends biased search result;

FIG. 2 is a schematic diagram of an aspect of an access terminal of the system;

FIG. 3 is a schematic diagram of an aspect of a network device of the system;

FIG. 4 is a flow chart of an aspect of a method of obtaining a friends biased search result;

FIG. 5 is a flow chart of an aspect of a method of providing a friends biased search result;

FIG. 6 is a message flow chart of an aspect of using a friends bias to provide more targeted/refined search results;

FIG. 7 is a message flow chart of an aspect of using a friends bias to filter search results; and

FIG. 8 is a flow chart of an aspect of using RFID in conjunction with WAN to generate information which may compliment a friends biased search result.

### DETAILED DESCRIPTION

The aspects disclosed herein relate to providing targeted search results based on at least one bias, such as a bias associated with one or more friends identified by a user.

A “user” disclosed herein may be construed broadly to include any entity initiating a search request (e.g., by submitting a query).

A “group” disclosed herein may include one or more users having a predetermined association, such that addressing to the group may effectively address all users associated with the group.

The term “friends” or “friends list” disclosed herein may be construed broadly to include one or more entities (e.g., a subset of a group) having a predetermined association based on one or more criteria. The criteria for forming a friends list may include, e.g., location, age, gender, hobbies, demographics, organizations/affiliations (e.g., clubs, sports teams, etc.), colleagues, family relations, personal relations, pets, etc.

The term “search” disclosed herein may include a process of submitting a query into a search database. The query may be tokenized. The query may be entered manually, verbally, and/or activated through other means.

A “search database” disclosed herein may include a database configured to store information that may be used to resolve a search query. The database may contain static (e.g., web information) and/or dynamic data (e.g., location, weather, mood, etc.).

A “friends search engine (FSE)” disclosed herein may include a search engine configured to use information derived from a friends list to bias (or refine), filter, and/or rank the search results, so as to provide more targeted/refined information to users, as examples described below further illustrate.

A “friends database (FDB)” disclosed herein may include a database storing friends lists associated with various users, which may be configured to be part of and/or work in conjunction with an FSE. A friends database may be generated and/or based on the information provided by a service provider, a communication network, or the like. A friends database may reside in a storage medium (e.g., a server), and may also be cached onto a user device (e.g., a client/personal computer, an access terminal, etc.).

In the described aspects, a user may further provide inputs into a friends database, or may provide feedback associated with the search results to a friends database. Such information may be used to assist/bias future searches initiated by users associated with the friends database.

An access terminal (AT) disclosed herein may refer to various types of devices, including (but not limited to) a wireless phone, a cellular phone, a laptop computer, a multimedia wireless device, a wireless communication personal computer (PC) card, a personal digital assistant (PDA), an external or internal modem, etc. An access terminal may be any data device that communicates through a wireless channel and/or through a wired channel (e.g., by way of fiber optic or coaxial cables). An access terminal may have various names, such as access unit, access node, subscriber unit, mobile station, mobile device, mobile unit, mobile phone, mobile, remote station, remote terminal, remote unit, user device, user equipment, handheld device, etc. Different access terminals may be incorporated into a system. Access terminals s may be mobile or stationary, and may be dispersed throughout a communication system. An access terminal may communicate with an access network (AN) on a forward link (FL) and/or a reverse link (RL) at a given moment.

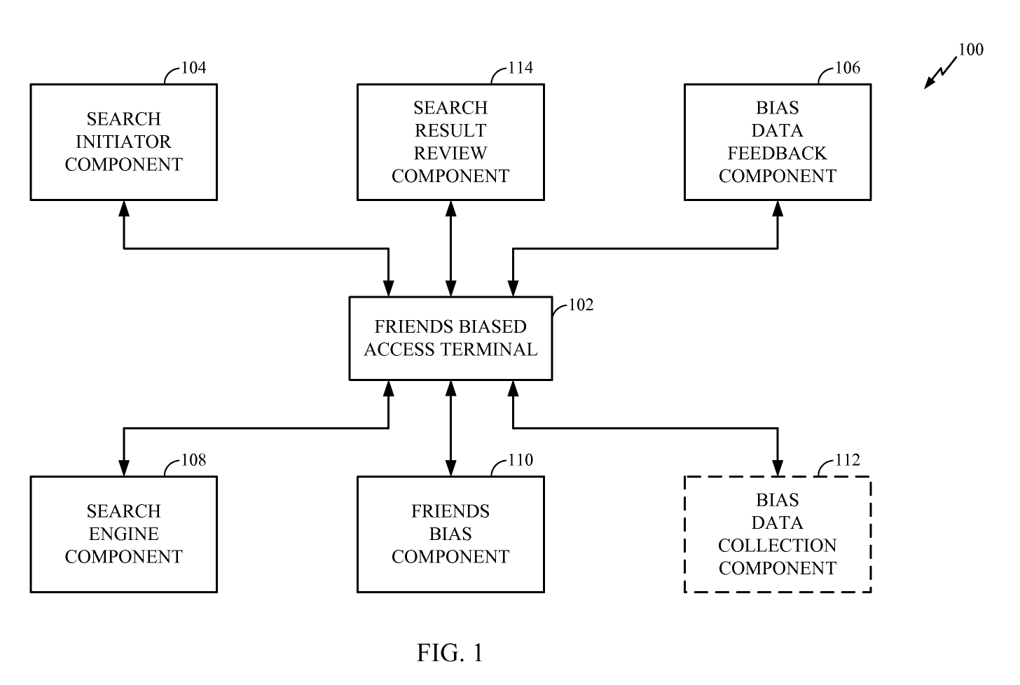

Referring to FIG. 1, a friends biased searching system 100 comprises one or more nodes, such as one or more access terminals 102 in one or more sectors, that receive, transmit, repeat, etc., wired or wireless communication signals to each other and/or to one or more other nodes, such as other mobile devices and/or fixed network devices. System 100 facilitates customizing a search result for a given user in response to a query initiated by the user. More particularly, system 100 provides for a search result corresponding to a query submitted by a user of access terminal 102 to be biased or otherwise modified based on data associated with one or more friends of the user. For example, rather than receiving generalized search results in response to a query, where each user presenting the respective query receives substantially the same search result, system 100 allows for the search result to be customized for each user according to opinions, actions, or both, of an identified one or more friends of the user. Since a user typically identifies with or has a connection with one or more friends, the described aspects extend this identification and/or connection to data corresponding to friends to modify a search result in an attempt to increase the pertinence of the search result to the user. Thus, in contrast to the indiscriminate search results, system 100 allows for search results to be tailored and/or personalized to a given user based on opinions and/or actions of one or more identified friends of the user, thereby providing individualized, perceptive, and insightful results likely to have more relevance to the given user than the generalized search results.

Access terminal 102 is employed by a user, who can manipulate access terminal 102 to input a query to which the user desires an answer. System 100 includes a search initiator component 104 operable to receive the query. In one optional aspect, search initiator component 104 may further obtain enhancement data to add to the query. For example, enhancement data may include, but is not limited to, data such as location-related data corresponding to the access terminal 102, user profile data, access terminal configuration data, any data relating to the access terminal 102, any data relating to the user of the access terminal, any data relating to the environment associated with the access terminal, or any combination thereof. System 100 may allow for the addition of the enhancement data to provide a context to the query, and to further allow the search results to be customized to the respective user.

Optionally, system 100 may include a bias identification component 108 operable to identify a particular bias for use with the query, or to input bias data into system 100. For example, bias identification component 108 may receive from the user an indication of a friend, or a friends list or group, to be used in performing searches to generate biased search results. In another example, bias identification component 108 may receive inputs including, but not limited to, user preferences, transactions, feedback or opinions, or combinations thereof, for input into a database for use in biasing search results, either for the user or for another user who has identified the user as a friend or as part of a group or friends list.

Subsequently, search initiator component 104 may forward the query, and optionally the enhancement data, to a search engine component 108 for processing. For example, search engine component 108 is operable to search one or more computer systems, such as the World Wide Web, to gather information related to the query, and optionally further considering the enhancement data. The gathered information may be referred to as a search result. For example, the search result includes, but is not limited to, data as well as interactive links to the source of the data within the respective computer system.

Once a search result has been obtained, system 100 includes one or more components operable to modify or bias the search result according to bias data from one or more friends or groups as identified by bias identification component 106. For example, one or more friends, groups, or friends lists, each having corresponding bias data, may be stored in a friends bias component 110. Friends bias component 110 may include a memory, storage, or any combination thereof, for retaining the bias data. As noted above, the bias data may include any data associated with the respective friend that can be used to reformulate or filter the search result. For example, bias data may include, but is not limited to, data such as an opinion responsive to a polling question, transactional data gathered from a transaction such as a purchase made by the friend, friend profile data including demographic and/or psychographic data, and location-related data. In one aspect, a bias manager component 112 may be operable to establish one or more groups or friends lists for the user on friends bias component 110, including the identification of one or more friends and their corresponding bias data. For example, in a data collection mode, bias manager component 112 may be operable to gather the bias data from each friend established in friends bias component 110, and to manage the list of friends for each of a plurality of users of system 100. It should be noted that bias manager component 112, although illustrated as an independent component in the depicted aspect, may be included as a part of friends bias component 110.

In a bias applying mode, system 100 is operable to consider the bias data corresponding to a friend or a friends lists or a group comprising a plurality of friends, as identified by bias identification component 106, according to one or more predetermined algorithms, routines or logic to generate a friends biased search result. Optionally, in the bias applying mode, system 100 may further consider the enhancement data in combination with the bias data in order to determine the friends biased search result. In one aspect, search engine component 108 is operable to gather the respective bias data and generate the biased search result. In another aspect, friends bias component 110 is operable to generate the biased search result. In still another aspect, bias manager component 112 is operable to generate the biased search result.

In any case, the biased search result responsive to the query of the user is obtained on access terminal 102. A search result review component 114 is operable to receive or access the biased search result, and output the biased search result for presentation to the user. Further, for example in a case where the biased search result comprises one or more links to information, such as web pages on the World Wide Web, search result review component 114 may be further operable to receive user inputs to further interact with search engine component 108 to gather desired information corresponding to a selected link. In another aspect, search result review component 114 may additionally interact with search initiator component 104, bias identification component 106, or a combination thereof, to reformulate the query or input a new query, or change the indicated friends bias, based on the biased search result, for submission to search engine component 108.

Therefore, responsive to a search engine query, system 100 allows for obtaining friends biased search results likely to have a higher degree of relevance to a user compared to generic search results returned by other search engines.

It should be noted that one or more of the components of FIG. 1 may be implemented on access terminal 102, or from another device in communication with access terminal 102, such as a network device. Further, the components of FIG. 1 may be implemented separately or in any combination in hardware, software, firmware, or combinations thereof.

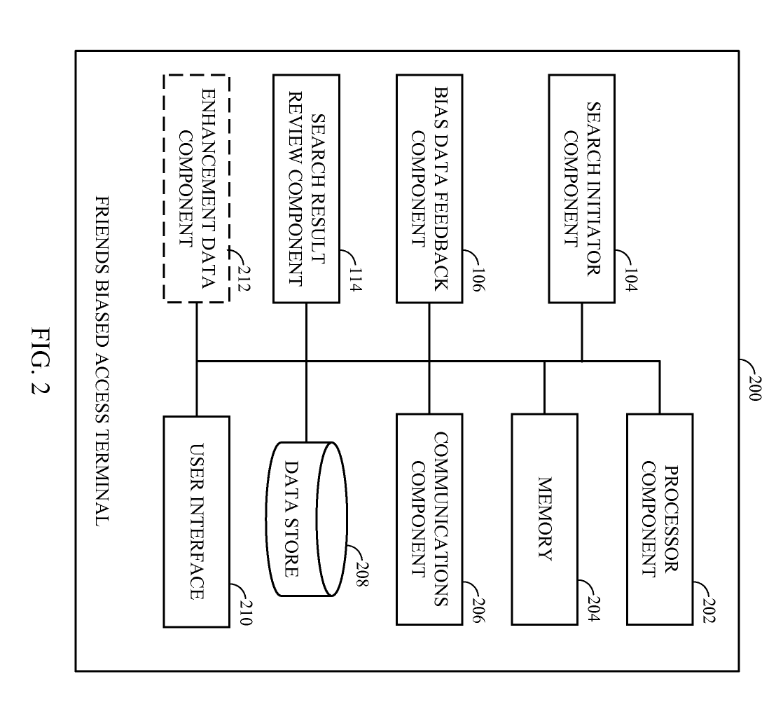

Referring to FIG. 2, one aspect of friends biased access terminal 200 includes a mobile communication device operable on a wireless communication system. As can be appreciated, there are a variety of wireless communication systems, which often employ different spectrum bandwidths and/or different air interface technologies. Exemplary systems include code division multiple access (CDMA) (CDMA 2000, evolution data only (EV DO), wideband code division multiple access (WCDMA)), frequency division multiple access (OFDM), or orthogonal frequency division multiple access (OFDMA) (Flash-OFDM, 802.20, worldwide interoperability for microwave access (WiMAX)), frequency division multiple access (FDMA)/time division multiple access (TDMA) (global system for mobile communications (GSM)) systems using frequency division duplex (FDD) or time division duplex (TDD) licensed spectrums, peer-to-peer (e.g., mobile-to-mobile) ad hoc network systems often using unpaired unlicensed spectrums, and 802.xx wireless local area network (LAN) or BLUETOOTH techniques.

Access terminal 200 includes processor component 202 for carrying out processing functions associated with one or more of components and functions described herein. Processor component 202 can include a single or multiple set of processors or multi-core processors. Moreover, processing component 210 can be implemented as an integrated processing system and/or a distributed processing system.

Access terminal 200 further includes a memory 204, such as for storing local versions of applications being executed by processor component 202. Memory 204 can include random access memory (RAM), read only memory (ROM), or a combination thereof.

Further, access terminal 200 includes a communications component 206 that provides for establishing and maintaining communications with one or more parties utilizing hardware, software, and services as described herein. Communications component 206 may carry communications between components on access terminal 200, as well as between access terminal 200 and external devices, such as devices located across a communications network and/or devices serially or locally connected to access terminal 200. For example, but not limited hereto, communications component 206 is operable to provide an interface between search initiator component 104 and search engine component 108, between bias identification component 106 and friends bias component 110 and/or bias manager component 112, and between search result review component 114 and search engine component 108.

Additionally, access terminal 200 may further include a data store 206, which can be any suitable combination of hardware and/or software, that provides for mass storage of information, databases, and programs employed in connection with aspects described herein.

Access terminal 200 may additionally include a user interface component 210 operable to receive inputs from a user of access terminal 200, and to generate outputs for presentation to the user. User interface component 210 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 210 may include one or more output devices, including but not limited to a display, a speaker, a haptic feedback mechanism, a printer, any other mechanism capable of presenting an output to a user, or any combination thereof.

Additionally, in the illustrated aspect, access terminal 200 may include search initiator component 104, bias identification component 106 and search result review component 114, as discussed above. In the depicted aspect, search engine component 108, friends bias component 110 and bias manager component 112 may be located on one or more other devices, for instance on one or more network servers. It should be noted, however, that all or some portion of one or any combination of search engine component 108, friends bias component 110 and bias manager component 112 may be located locally on access terminal 200, for example, to assist in generating biased search results when access terminal 200 is not in communication with a communications network.

In one optional aspect, access terminal 200 may additionally include an enhancement data component 212 operable to gather or generate or manage, or any combination thereof, the enhancement data that may be used to supplement the query submitted by the user to search engine component 108. For example, the enhancement data may include, but is not limited to, data such as location-related data corresponding to the access terminal, user profile data, access terminal hardware configuration data, access terminal software configuration data, access terminal firmware configuration data, any other data relating to the access terminal, any other data relating to the user of the access terminal, any other data relating to the environment associated with the access terminal, or any combination thereof. Such data may be obtained from components operating on access terminal, such as subsystems associated with processor component 202 or other components or applications executed by processor component 202 or in communication with access terminal 200. For example, enhancement data component 212 may include data from a position/location system, including an independent geographic positioning system such as GPS, a communications network-based positioning system, or some combination of both. Further, enhancement data component 212 may include user profile information that includes demographic data or psychographic data, or some combination thereof, of the user that may be gathered based on polling questions or based on monitoring user activity with respect to the utilization of components on access terminal 200 or based on monitoring interactions between access terminal 200 and external devices. Further, enhancement data component 212 may be operable to interface with search initiator component 104 in order to supplement the query with corresponding enhancement data to provide context for the query. Additionally, enhancement data component 212 may be further operable to interface with any other components of system 100 to facilitate the functionality described herein.

Additionally, access terminal 200 may execute any one of search initiator component 104, bias identification component 106, search result review component 114 and enhancement data component 212 via processor component 202, store corresponding data and information in one or both of memory 204 and data store 208, transfer corresponding messages and data locally or externally via communications component 206, and receive corresponding inputs and generate corresponding outputs via user interface 210.

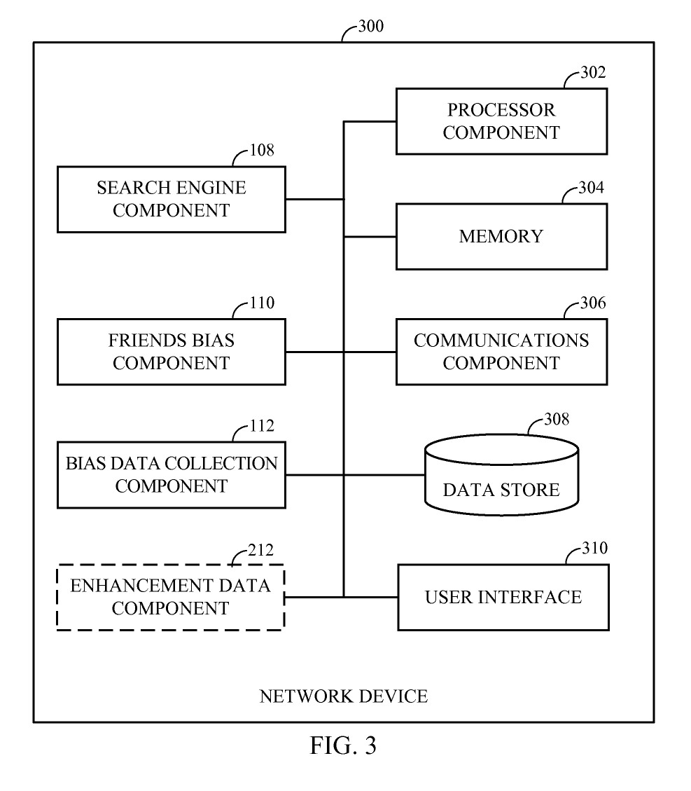

Referring to FIG. 3, in an aspect where some of the components of system 100 are implemented at another device besides access terminal 102 (FIG. 1), a network device 300 is operable to interface with access terminal 102 (FIG. 1) or 200 (FIG. 2) in performing the friends biased search. Network device 300 includes any type of network-based communication device, such as a network server operable on a communication system. Communication system may be a wired or wireless communication system, and is connected to the wireless communication system on which access terminal 102 operates.

Network device 300 includes a processor component 302 for carrying out processing functions associated with one or more of components and functions described herein. Processor component 302 can include a single or multiple set of processors or multi-core processors. Moreover, processor component 302 can be implemented as an integrated processing system and/or a distributed processing system.

Network device 300 further includes a memory 304, such as for storing local versions of applications being executed by processor component 302. Memory 304 can include random access memory (RAM), read only memory (ROM), or a combination thereof.

Further, network device 300 includes a communications component 306 that provides for establishing and maintaining communications with one or more parties utilizing hardware, software, and services as described herein. Communications component 306 may carry communications between components on network device 300, as well as between network device 300 and external devices, such as access terminal 200, and including devices located across a communications network and/or devices serially or locally connected to network device 300. For example, but not limited hereto, communications component 306 is operable to provide an interface between search engine component 108 and search initiator component 104, between friends bias component 110 and/or bias manager component 112 and bias identification component 106, and between search engine component 108 and search result review component 114.

Additionally, network device 300 may further include a data store 306, which can be any suitable combination of hardware and/or software, that provides for mass storage of information, databases, and programs employed in connection with aspects described herein.

Network device 300 may additionally include a user interface component 310 operable to receive inputs from a user of network device 300, and to generate outputs for presentation to the user. User interface component 310 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 310 may include one or more output devices, including but not limited to a display, a speaker, a haptic feedback mechanism, a printer, any other mechanism capable of presenting an output to a user, or any combination thereof.

Additionally, in the illustrated aspect, network device 300 may include search engine component 108, friends bias component 110 and bias manager component 112, as discussed above. In the depicted aspect, search initiator component 104, bias identification component 106 and search result review component 114 may be located on one or more other devices, for instance on one or more access terminals 200 (FIG. 2). It should be noted, however, that all or some portion of one or any combination of search engine component 108, friends bias component 110 and bias manager component 112 may be located locally on network device 300, for example, to assist in generating biased search results when access terminal 200 is not in communication with a communications network.

In some optional aspects, network device 300 may additionally include enhancement data component 212, as described in detail above. In these optional aspects, enhancement data component 212 may be operable to gather or generate or manage, or any combination thereof, the enhancement data that may be used to supplement the query submitted by the user to search engine component 108. For instance, due to limited memory or processing resources, enhancement data component 212 may be resident on network device 300, which is likely to have more available resources than a resourced constrained access terminal such as a wireless device.

Additionally, network device 300 may execute any one of search engine component 108, friends bias component 110, bias manager component 112 and enhancement data component 212 via processor component 302, store corresponding data and information in one or both of memory 304 and data store 308, transfer corresponding messages and data locally or externally via communications component 306, and receive corresponding inputs and generate corresponding outputs via user interface 310.

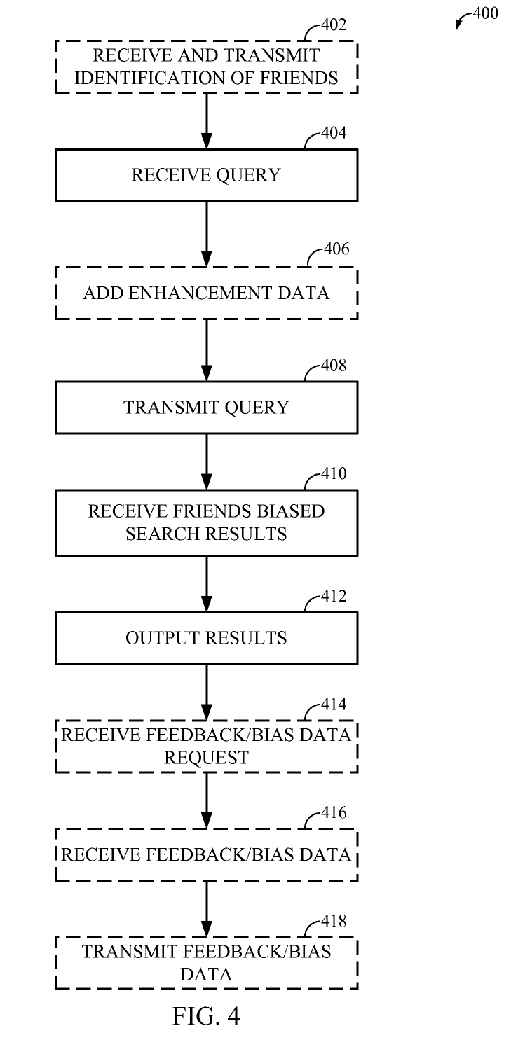

Referring to FIG. 4, in one aspect, a method 400 of obtaining search results includes, optionally, receiving and forwarding an identification of one or more friends for use in biasing search results (Block 402). For example, the method may include receiving from a user a name or a code that identifies an individual, a group of individuals, a friends list, or some other characteristic that defines one or more other participants for whom the user desires to be utilized to modify search results obtained by the user. For instance, the identified friend may include a selection of a friend or a group of friends from a list of friends. Further, for instance, the identified friend may include a definition of a range of ages, locations, interests, or any other characteristic or combination of characteristics that may define a friend. Consequently, it should be noted that a friend may not need to be known by the user identifying the friend. Further included in this action is forwarding the identification of the friend or group of friends to a respective component in the system responsible for or associated with modifying search data based on bias data corresponding to the identified friend or group.

The method further includes receiving query data from the user (Block 404). For example, the user may input a search query into an application or service running on a device, which is operable to perform search engine functionality or interface with a search engine. A part of receiving the query data may include receiving an identification of a search engine to be used, and/or an identification of a computer system to be searched with respect to the query.

In an optional aspect, the method may further include adding enhancement data to the query. For example, the enhancement data may be added as indicated by a user, or the method may have a predetermined setting that allows for enhancement data to be added. For instance, the method may include receiving a query relating to a given product or service, and the method may include adding a geographic location of the device to the query in order to provide a context to the query. Further, for example, the method includes the addition of other types of enhancement data, such as data relating to the device, data relating to the user of the device, and combinations thereof.

The method further includes transmitting the query, and optionally any supplemental enhancement data, for use in performing a search of information relating to the query on one or more computer systems (Block 408). For example, the method may include transmitting the query to one or more search engines each operable to gather query-related data from one or more computer systems. Such a search engine may be resident on the device receiving the query, or on an external device such as a server communicating across a communications network. Further, the search engine in receipt of the query may include, or may be in communication with friends bias data for use in modifying search results to generate friends biased search results. The respective friends bias data utilized corresponds to data associated with the identified friends (Block 402).

The method additionally includes receiving a friends biased search result in response to the query (Block 410). As noted above, in one example, this action includes receiving the friends biased search result from another device across a communications network, such as a network server. In another example, a non-biased search result may be received on the query-transmitting device, and another component on the device may have access to either a resident or a remote database of friends bias data corresponding to the identified friends (Block 402), and may further generate the friends biased search result. For example, the friends biased search result includes modifications to the non-biased search result based on the bias data of the identified friends. The modifications, for example, may be made according to a predetermined algorithm, routine, heuristic, neural network, or any other one or combination of decision-making mechanisms. Further, the modifications may involve including, excluding, reordering, or a combination thereof, of the original information in the search result according to the friends bias data, thereby resulting in the friends biased search result. Additionally, it should be noted that the friends biased search results may be stored in a memory or data store.

Further, the method includes outputting the friends biased search results for presentation to the user (Block 412). For example, the method may include displaying or printing out the biased search results in a manner to be viewed by the user. Also, the method may include audibly reciting the biased search results, or any other method of conveying the biased search results in a manner that can be understood by the user. Additionally, for example, this aspect of the method may further include outputting the search results in an interactive manner that allows the user to gather additional information corresponding to an item within the biased search result, such as clicking on a link to a web page, or that allows the user to modify any aspect of the original query to further refine the query.

In an optional aspect, the method may further include the collection of feedback from the user with respect to the query, or with respect to bias data for use in the operation of the system. In particular, the method may include receiving and presenting to the user a request for feedback or bias data (Block 414). As noted, the feedback may be based on the actions taken by the user after receiving the biased search results. For example, if a user decides to purchase a good or service based on the biased search result, the system may prompt the user to provide feedback relating to the purchased good or service. In another aspect, this request may relate to the collection of bias data of the respective user for use in the system to help produce biased search results for queries on which the user has been identified as a friend. As such, this request may be a polling question to establish a user opinion, may be triggered by actions of the user such as related to a commercial transaction, etc.

Further, this optional aspect includes receiving feedback data or bias data in response to the request (Block 416). For example, such data may be proactively entered by the user, or may be passively tracked by a component of the device of the user.

Additionally, this optional aspect further includes transmitting the feedback data or bias data for use in the friends bias search result system (Block 418). For example, the method may include transmitting the feedback data or bias data to another computer device across a network, such as a network server, or to a local component operable to manage biasing activities.

Thus, the above-described method allows for the identification of friends for use in modifying search results to obtain friends biased search results, and for the collection of feedback data or bias data for use in the method.

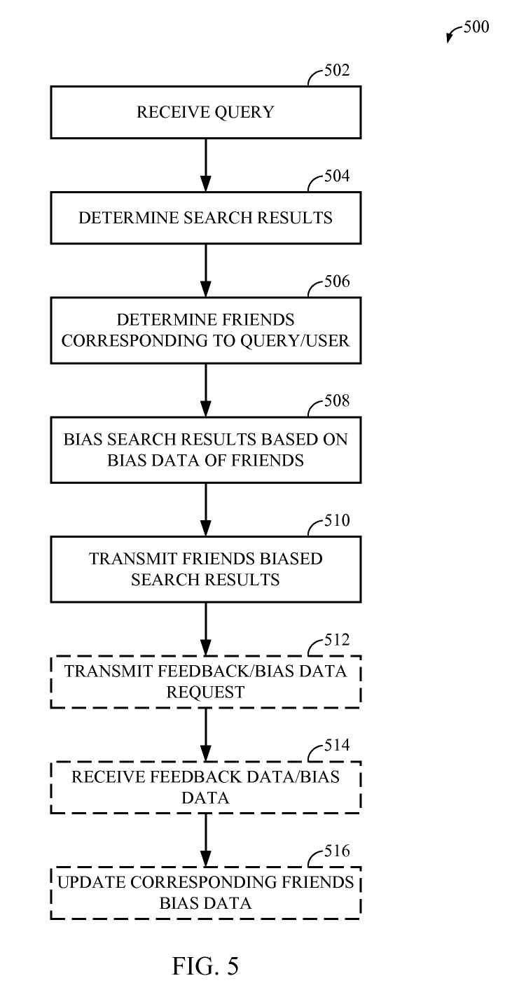

Referring to FIG. 5, in one aspect, a method 500 of providing search results includes receiving a search query from a user (Block 502). For example, the query may include data relating to a question or issue for which the user desires to discover information. In some optional aspects, receiving of the query may further include receiving enhancement data that provides a context to the query, such as data relating to the user or the user device. The enhancement data may be helpful in refining the search to match the current characteristics associated with the user or with the user device. Additionally, in some optional aspects, the query may further include friends information operable to identify bias data of friends to be used in determining the results of the query. Further, for example, the receiving of the query may occur at a search engine, or at an interface to a search engine, wherein the search engine is operable to act on the query.

The method further includes determining search results in response to the query (Block 504). For example, determining search results includes identifying matches between data in the query and data associated with information in one or more computer systems. For instance, a web search engine may determine search results comprising data associated with and links to web pages on the World Wide Web.

Additionally, the method includes determining friends corresponding to the query or to the user submitting the query (Block 506). For example, as noted above, the query may include an identifier that indicates predetermined friends for use in modifying search results. For instance, the system may include a list of friends, and the determination may include the identification of one or a group of friends from a friends list. In other aspects, for example, the determining of friends may be based on identifying a system setting that identifies friends for a given user or device. Still other aspects include separate communications received from the user that define friends for use in determining the result of the query.

The method further includes biasing the search results according to bias data of the identified friends (Block 508). For example, the biasing includes modifying information within the search results to include, exclude, or include and exclude, portions of the information depending on the friends bias data. For instance, the inclusion of information may involve generating biased search results having items that match with, correspond to, or correlate with the bias data. For instance, a predetermined algorithm, heuristic, neural network, artificial intelligence, or any combination thereof, may be used to perform the matching and organize the results, which may include reordering items within the search result or which may involve only including matching information. On the other hand, for instance, the exclusion of information may operate to remove matching/corresponding/correlating information from the search results, or to move the matching information to a lower priority than the non-matching information, in order to generate the biased search result.

The method may further include transmitting the friends biased search results for presentation to the user (Block 510). For example, the transmitting may include forwarding the biased search results across a communications network to a device of the user initiating the query. In another example, the transmitting may involve forwarding the bias search results locally on a single device to another device component operable to save and/or output the biased search results.

In additional optional aspects, the method may further include collecting of feedback or bias data for use in the system. As such, the method may optionally include transmitting a feedback or bias data request to prompt a user or user device to supply feedback or bias data (Block 512). For example, the feedback request may be based on the biased search result of the query. In another example, the request for bias data may be part of the management of the system in order to stock the biasing components with relevant bias data.

Further, this optional aspect of the method may additionally include receiving feedback data or bias data in response to the request (Block 514). In one aspect, the feedback or bias data may be input by a user and received from a local or remote user device. In another aspect, the feedback or bias data may be passively collected from the user device.

Additionally, this optional aspect of the method further includes updating the friends bias data in the system with the received feedback or bias data (Block 516). For example, updating of the friends bias data may include adding the data to a memory, data store or other database operable to retain the data in relation to the respective user who supplied the data. Such data may then be utilized to generate biased search results in the manner described above.

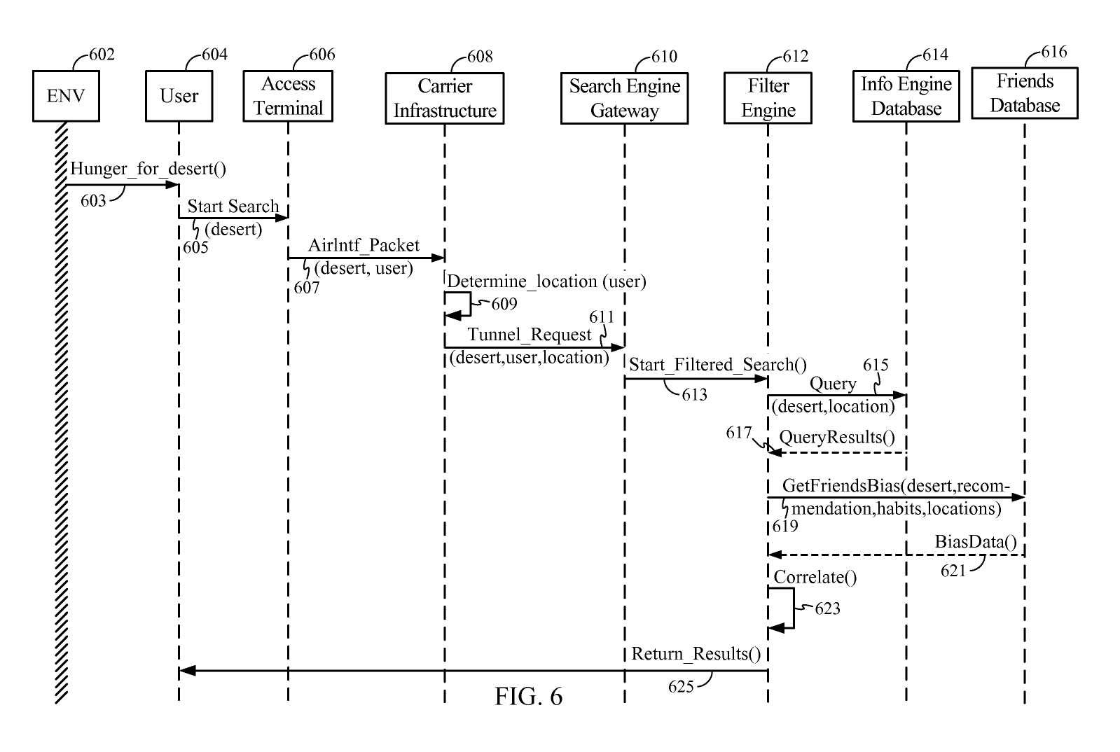

FIG. 6 illustrates an embodiment of using a friends list to bias and refine a search (e.g., using information derived from a friends list to indicate a user's preference). By way of example, an environment (ENV) 602 of a user 604, named Mike, includes Event 603 that defines a desire for dessert. For example, Mike wants to have a piece of cheesecake. Mike decides to use the FSE (one or any combination of a search engine gateway 610, a filter engine 612, an information engine database 614 and a friends database 616) provided by Mike's access terminal 606 via a carrier infrastructure 608, for example, to search for the best cheesecake restaurant in the area (e.g., the city where Mike lives or is visiting). The FSE may be configured to assist Mike in finding the best cheesecake restaurant, e.g., based on the characteristics and/or preferences of Mike's friends, and other variables such as conjunction with time of day, weather, location, etc.

As illustrated in FIG. 6, the events/messages are defined as follows:
603: Hunger for desert—Mike wants to a piece of cheesecake.
605: Start Search—Mike inputs the search query “best cheesecake” into Mike's access terminal (e.g., a mobile phone). The access terminal initiates a data call/request to the network (e.g., the corresponding AN 608).
607: Transmission media—The query is transmitted (e.g., over the air) from Mike's access terminal to the carriers infrastructure. For example, the transmission media may include a data packet including information relating to the query and the user.
609: Determine Location—The AT information is determined to be an FSE query. Service provider information is added to enhance the query. Location of the user, time of day, weather in the area, and other information may also be added to the query. (For clarity and brevity, the parameter location may be used as abbreviation for all terms that relate to enhancing the query.)
611: Tunnel Request—The request is being forwarded to a search engine gateway. The gateway may be responsible for identifying the user in global scope.
613: Start Filtered Search—The search engine gateway connects to a search engine for resolving the query.
615: Query—A filter engine (FE) may be configured to submit the generic search query and then aid in filtering (reordering and/or removing) the results. A standard query (e.g., “best cheesecake”) is sent to the info engine database.
617: Query Results—Results of query (unfiltered).
619: Get Friends Bias—The filter engine may then request for friends information pertaining to the query and location, e.g., from a friends database. Such information may be termed as “friends bias' herein.
621: Return Bias Data—The friend database returns the respective bias data of the friends in response to the request.
623: Correlate—The query and the bias are correlated to produce the returning query result. The correlation may be configured to provide Mike with the best cheesecake as biased by Mike's friends.
625: The search result is returned to Mike.

Upon review of the search engine results, if Mike decides to visit the recommended restaurant, Mike may inform the friends database of Mike's decision, along with Mike's feedback regarding the cheesecake (and/or other food) served at the restaurant. Mike's access terminal may also be configured to prompt Mike to enter Mike's feedback regarding the cheesecake and/or associated restaurant, which may then be stored in the friends database. In one application, a message (e.g., short message service (SMS)) may be sent to Mike's access terminal, prompting Mike to send Mike's feedback regarding the cheesecake (and/or other food) at the restaurant to the corresponding AN, which may then forward the information to the friends database. In another application, Mike's activities (e.g., time and frequency associated with visiting the cheesecake restaurant) may be monitored by various types of proximity detection services (e.g. AT, RFID, GPS, AT, credit card transaction, camera, and other monitoring/tracking means), and further stored in the friends database. The feedback information may aid Mike and Mike's friends in future searches.

In one implementation, search engine gateway, filter engine, info engine database, and friends database illustrated in FIG. 6 may be elements (or modules) included in a single entity. In another aspect, search engine gateway, filter engine, info engine database, and friends database illustrated in FIG. 6 may be separate elements configured to work in conjunction. For example, the friends database may comprise the address book and/or contact list on user's access terminal, which may be forwarded to the friends bias component and referenced when a user provides a friend identification. The friends database may also be cached on the user's access terminal (e.g., in situations where the user is disconnected from the friends database).

An example of how an FSE may use information provided by the friends database to improve/enhance the search results is illustrated as follows.
1) Mike uses his access terminal to send a query into the FSE for the “best milk shake shop.”
2) The FSE collects user information (e.g. Mike, location, weather, time of day, etc.) and the search query “best milk shake shop.”
3) The FSE contacts the friends database to determine Mike's friends (Chad, Jeff, Jan, etc.).
4) The friends database returns Mike's friends: e.g., Chad, Jeff and Jan and a set of biases for each friend to the FSE.
5) The friends database also returns Mike's biases to the FSE.
6) The FSE processes the biases and determines that Chad prefers chocolate and strawberry milk shakes from the “Cubs Diner” and has visited the diner 98 times.
7) The FSE processes the biases and determines that Jeff prefers vanilla milk shakes from the “Kimball Farms Market.”
8) The FSE processes the biases and determines that Jan prefers chocolate milk shakes from the “88 Flavors Ice Cream Shop.”
9) The FSE builds a database of possible results using the friends biases.
10) The FSE processes Mike's biases and determines that Mike does not like chocolate milk shakes.
11) The FSE filters out Jan's bias and one of Chad's biases (Chocolate) from the list of possible results.
12) The FSE uses time and location to determine that Mike cannot reach “Cubs Diner” before it closes at 7:08 pm, thus removing “Cubs” diner as a possible result.
13) The FSE returns “Kimball Farms Market” market to Mike and recommends a vanilla shake for purchase.
14) Mike decides to go to “Kimball Farms Market.”
15) Mike purchases a vanilla milk shake at “Kimball Farms Market.”
16) A proximity detection service (e.g. AT, RFID, credit card transaction, camera, etc.) notifies the FSE that Mike has visited “Kimball Farms Market.”
17) The FSE updates the friends database on which shop (Kimball Farms Market) Mike has visited and the type of shop.
18) At some time after purchasing the shake, the FSE contacts Mike and asks him to rate the shop and to comment on the selection.
19) Mike returns that he enjoyed the milk shake to the FSE; subsequently the FSE updates the friends database (thus allowing Mike and his friends to make use of this information in future searches).
20) Using the access terminal, Mike takes a photo of the shop and the milk shake and submits the photo to the FSE to update Mike's biases in the friends database. The photo may be provided in future queries that return “Kimball Farms Market” as a search result.

An example of using a pet (e.g., dog) as a friend entity) is illustrated as follows:
1. Jeff wants to find out which dog parks Jeff's friends takes his dog.
2. Jeff enters a query to an FSE to provide GPS tracking results for his friend's dog.
3. The FSE references the results against common query for dog parks.
4. The FSE returns results which include dog parks that Jeff's friend has taken his dog.

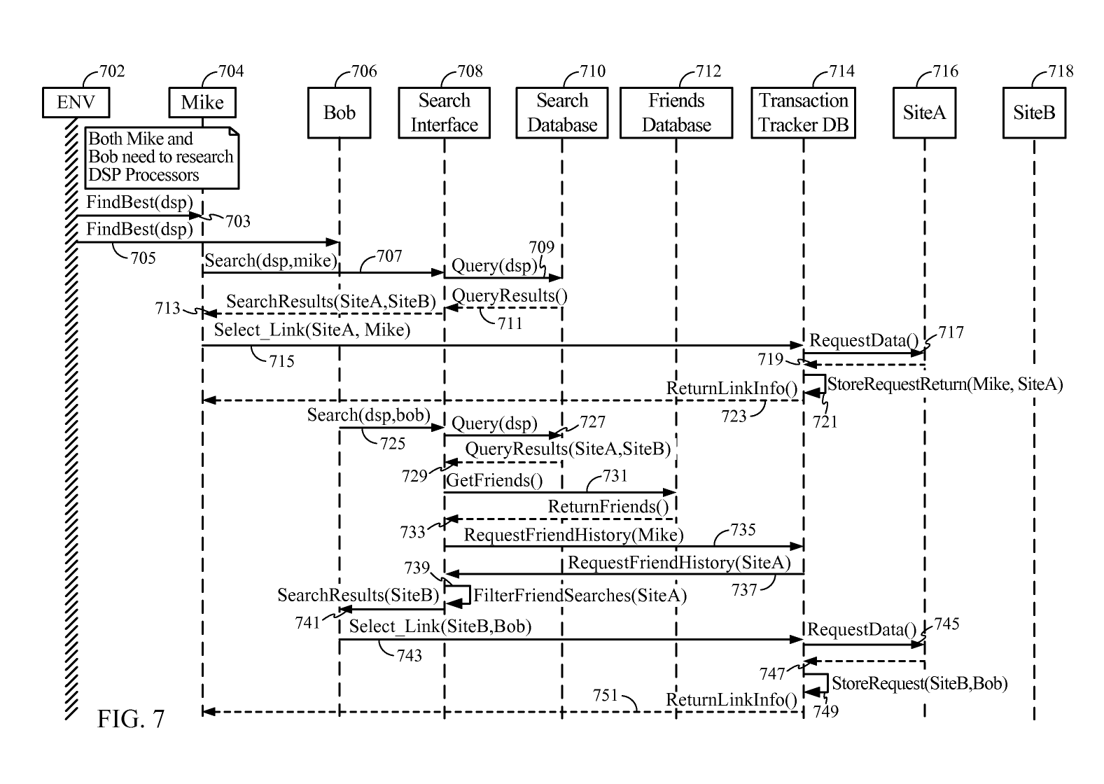

FIG. 7 illustrates an embodiment of two coworkers (e.g., Mike and Bob) doing research on digital signal processors (DSPs), where a friends list may be used in an exclusionary manner, e.g., to avoid displaying duplicate results and thus render the search process more efficient. By way of example, Mike 704 and Bob 706 decide to use internet searching to aid in Mike and Bob's DSP research 702. The search based on the same (or similar) queries from both users would return nearly identical results. By using the exclusionary function of the FSE (one or any combination of search interface 708, search database 710, friends database 712, and transaction tracker database 714), however, both users may view search results with less redundant effort, as further described below.

As illustrated in FIG. 7, the events/messages are as follows:
703: Find Best—Mike is asked to find the best DSP.
705: Find Best—Bob is asked to find the best DSP.
707: Search—Mike begins a search for the best DSP.
709: Query—The search interface queries the search database for “best DSP”
711: Query Result—Results are returned to the search interface. At this point the search interface 708 may use a friend filter (Mike and Bob being friends) (see 739) to refine the results.
713: Search Result—The results are returned to Mike.
715: Select Link—Mike selects the first link returned by an FSE. The selection is subsequently sent to a transactional tracker database 714 configured to record the link usage.
717: Request Data—The link tracker database requests link data from SiteA.
719: Request Data Return—SiteA returns data.
721: Store Request Return—The link tracker database stores information regarding the request (Mike, SiteA) and the return.
723: Return Link Info—SiteA information returned to user.
725: Search (bob)—Bob begins a search for the “best DSP.”
727: Query—The search interface submits a query to the search database.
729: Query Result—The query results in two sites, e.g., SiteA and SiteB.
731: Get Friends Info—The search interface queries for friends of Bob.
733: Return Friend Info—Returns friends of Bob, e.g., Mike, etc.
735: Request Friend History—Requests a link history of friends in connection with the search criteria.
737: Return Friend History—Returns the link history of friends in connection with the search criteria.
739: Filter Friends Searches—Correlates the link history of friends with the initial query results, which results in a more refined search result. For example, duplicate links may be removed (e.g., SiteA 716 may be removed from the search results for Bob).
741: Search Results—The search results are returned to Bob.
743: Select Link—Bob selects SiteB 718 and the link traversal is forwarded to the link tracker database.
745: Request Data—The link tracker database requests link data from SiteB.
747: Request Data Return—SiteB returns data.
749: Store Request Return—The link tracker database stores information regarding the request (Bob, SiteB) and the return.
751: Return Link Info—SiteB information returned to user.

In one implementation, tagging may be used to mark the search. Tagging may be in the form of a timestamp or handle, for example.

In another aspect, dynamic behavior may be implemented in a search process, e.g., displaying a link which has just been visited by a friend. Such allows the search information returned to Mike to be updated more readily (e.g., in substantially real-time) when a friend (e.g., Bob) follows a link.

The friends lists and the friends database (such as described above) may be updated in various manners. For example, the user's access terminal may prompt the user to send feedback associated with one or more search results (e.g., the restaurants and dog parks described above) to the friends database. The user may voluntarily send updated information (e.g., places recently visited, changes in location, hobbies, preferences, etc.) to the friends database. In some embodiments, a user's purchasing history may be collected and used as a bias input in connection with searches. Various proximity services (e.g., RFID, GPS, store tracking, camera, AT, and other monitoring/tracking means) may also be utilized in monitoring/tracking users' activities and working in conjunction with the friends database.

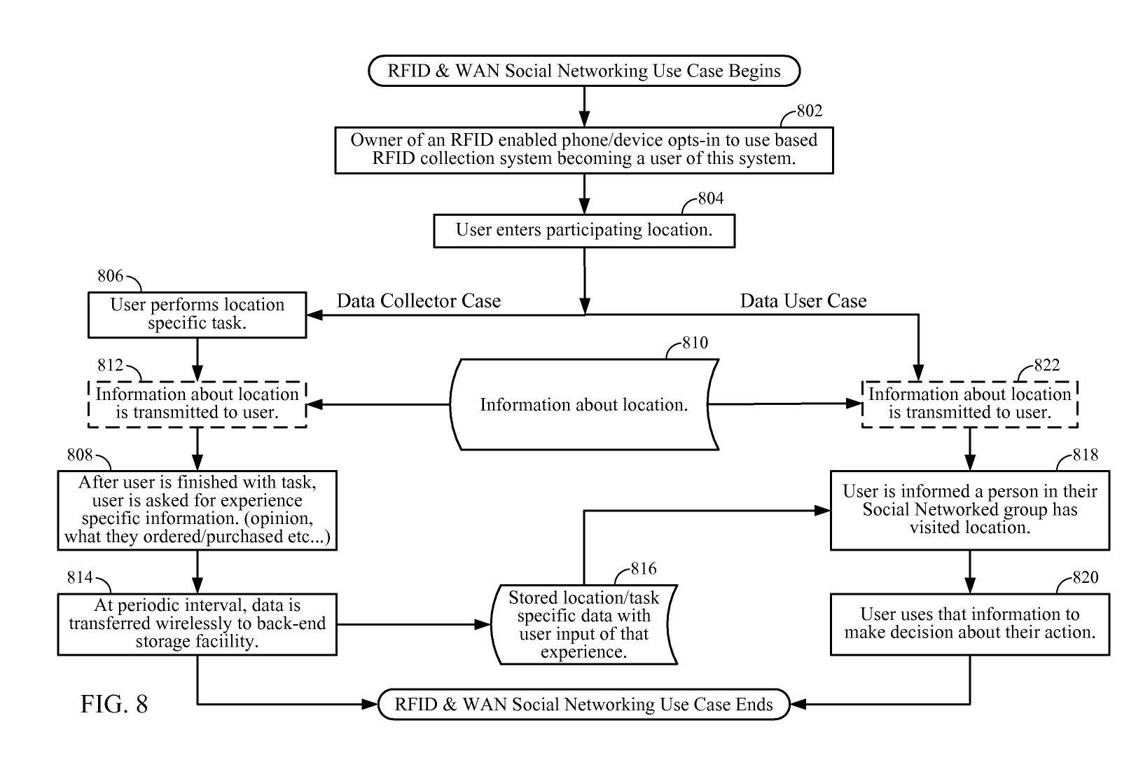

FIG. 8 illustrates a flow chart outlining a method 800 of using radio frequency identification (RFID) in conjunction with a wide area network (WAN) social network to generate information complimenting a friends list, e.g., to create custom search results.

The example of FIG. 8 may be used in searches for restaurants, movie theatres, shops, service stations, parks, clubs, and other recreation/entertainment/service venues. For example, a user may have a number/indicator associated with one or more other users on user's friends list (Block 802). For instance, upon opting-in to participate in the system, information relating the ID number to the user is stored in the system. Each time one of these users visits a restaurant, for example, such event (Block 804) may be picked up from an RFID tag (e.g., at the credit card machine) and transmitted back to the search engine's database. Further, entering a predetermined location may trigger either a data collector case or a data user case, or both. For example, in a data collector case, the activities of the user are tracked and later input into the system for use in biasing future activities, while in a data user case the activities of the user can be informed based on prior bias data from friends.

In the data collector case of the method, the method includes gathering bias data from a user based on actions or tasks performed by the user. For example, the user performs a location specific task (Event 806), such as purchasing a good or service. Upon completion of the task, the method includes asking the user for experience specific information (Event 808), such as an identification of and opinion related to the good or service purchased. Optionally, at any time after entering the participating location, information about the location (Event 810) may be transmitted to the user (Event 812), for example, triggered by an RFID token at an entrance or from an RFID credit card machine. Further, the method involves transmitting the gathered data to the friends biasing system (Event 814), where the gathered data is stored as bias data for the respective user (Block 816). When a user sends a search request for a new Asian restaurant, for instance, the results may be weighted based on the frequency of visits by other users on user's friends list.

Additionally, in a data user case, the method includes a user being informed of the bias data from one or more friends (Event 818), for example, based on the data gathered in the data collector case. Further, the method then includes the user being able to make a decision about the user's action based on the received friends bias data (Event 820). Optionally, at any time after entering the participating location, information about the location (Event 810) may be transmitted to the user (Event 822), for example, triggered by an RFID token at an entrance or from an RFID credit card machine for the use of the user while at the location.

The friends list need not be restricted to entities (e.g., people) the user initiating the search knows. The friends list may be based on location, age, gender, hobbies, demographics, organizations/affiliations, etc. For instance, a friends list may include all the males between 30 and 40 years old in Chicago, Ill. A user may use such a friends list to search for sports bars in Chicago, for example.

One or more aspects disclosed herein provide targeted search results based on user-based biases. One must appreciate that other aspects and implementations may exist. Various disclosed embodiments may be implemented in a search engine, a server, an access terminal, an AN, and other means.

Various units/modules and aspects disclosed herein may be implemented in hardware, software, firmware, or a combination thereof. In a hardware implementation, various units may be implemented within one or more application specific integrated circuits (ASIC), digital signal processors (DSP), digital signal processing devices (DSPDs), field programmable gate arrays (FPGA), processors, microprocessors, controllers, microcontrollers, programmable logic devices (PLD), other electronic units, or any combination thereof. In a software implementation, various units may be implemented with one or more modules (e.g., procedures, functions, and so on) that perform the functions described herein. The software codes may be stored in a memory unit and executed by at least one processor (or processing unit). The memory unit may be implemented within the processor or external to the processor, in which case it can be communicatively coupled to the processor via various means known in the art.

Those of skilled in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skilled in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

The steps or actions of a method or algorithm described in connection with the aspects disclosed herein may be embodied directly in hardware, in a software module executed by a processor, or in a combination of the two. Additionally, in some aspects, the steps and/or actions of a method or algorithm may reside as one or any combination or set of codes and/or instructions on a machine readable medium and/or computer readable medium, which may be incorporated into a computer program product. A software module may reside in random access memory (RAM), flash memory, read only memory (ROM), electrically programmable ROM (EPROM), electrically erasable programmable ROM (EEPROM), registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in an access terminal. In the alternative, the processor and the storage medium may reside as discrete components in an access terminal.

The previous description of the disclosed implementations is provided to enable any person skilled in the art to make or use the present aspects. Various modifications to these implementations will be readily apparent to those skilled in the art, and the generic principles defined herein may be applied to other implementations without departing from the spirit or scope of the invention. Thus, the present aspects are not intended to be limited to the implementations shown herein but are to be accorded the widest scope consistent with the principles and novel features disclosed herein.

What is claimed is:

1. A method of providing search results, comprising:
receiving a query initiated by a user;
performing a search based on the query;
determining a friends bias associated with the user;
biasing a search result based on the friends bias; and
storing the biased search result.

2. The method of claim 1, further comprising forwarding the biased search result to the user.

3. The method of claim 2, further comprising receiving user feedback associated with the biased search result and updating a friends database based on the user feedback.

4. The method of claim 1, wherein the determining comprises retrieving a friends bias data from a friends database.

5. The method of claim 4, wherein the retrieving further comprises retrieving based on a contact list stored in an access terminal associated with the user.

6. The method of claim 1, further comprising at least one of filtering the search result based on the friends bias, ranking the search result based on the friends bias, or filtering and ranking the search result based on the friends bias.

7. The method of claim 1, further comprising receiving information associated with activities of at least one of the user or friends identified by the user, and updating a friends database comprising the friends bias based on the information received.

8. The method of claim 1, further comprising obtaining enhancement data corresponding to the query, and wherein at least one of the performing of the search or the biasing of the search result is further based on the enhancement data.

9. The method of claim 1, wherein the biasing further comprises at least one of including or excluding information in the search result based on the friends bias.

10. The method of claim 9, wherein the excluding further comprises removing a portion of the search result that was previously provided to a predetermined user collaborating with the user who initiated the query.

11. A computer program product configured to provide search results, comprising:
a computer readable medium, comprising:
at least one instruction for causing a computer to receive a query initiated by a user;
at least one instruction for causing the computer to perform a search based on the query;
at least one instruction for causing the computer to determine a friends bias associated with the user;
at least one instruction for causing the computer to bias a search result based on the friends bias; and
at least one instruction for causing the computer to store the biased search result.

12. At least one processor configured to provide search results, comprising:
a first module for receiving a query initiated by a user;
a second module for performing a search based on the query;
a third module for determining a friends bias associated with the user;
a fourth module for biasing a search result based on the friends bias; and
a fifth module for storing the biased search result.

13. An apparatus for providing search results, comprising:
means for receiving a query initiated by a user;
means for performing a search based on the query;
means for determining a friends bias associated with the user;
means for biasing a search result based on the friends bias; and
means for storing the biased search result.

14. An apparatus for providing search results, comprising:
a communications component operable to receive a query initiated by a user;
a search engine component operable to perform a search and generate a search result based on the query;
a friends bias component comprising friends bias data associated with the user, wherein the search engine component or the friends bias component is further operable to generate a biased search result corresponding to a biasing of the search result based on the friends bias data; and
a storage component operable to store the biased search result.

15. The apparatus of claim 14, wherein the communications component is further operable to forward the biased search result to the user.

16. The apparatus of claim 15, wherein the search engine component or the friends bias component is further operable to receive user feedback associated with the biased search result and further operable to update the friends bias based on the user feedback.

17. The apparatus of claim 14, wherein the friends bias component further comprises a friends database operable to store the friends bias data.

18. The apparatus of claim 17, wherein the friends bias data is associated with a contact list stored in an access terminal associated with the user.

19. The apparatus of claim 14, wherein the search engine component or the friends bias component is further operable to perform at least one of filtering the search result based on the friends bias, ranking the search result based on the friends bias, or filtering and ranking the search result based on the friends bias.

20. The apparatus of claim 14, wherein the search engine component or the friends bias component is further operable to receive information associated with activities of at least one of the user or friends identified by the user, and to update the friends bias based on the information received.

21. The apparatus of claim 14, wherein the query is further associated with enhancement data, and wherein the search engine component is further operable to perform the search based on the bias data, or wherein the search engine component or the friends bias component is further operable to further bias the search result based on the enhancement data.

22. The apparatus of claim 14, wherein the search engine component or the friends bias component is further operable to bias the search result based on at least one of including or excluding information in the search result based on the friends bias.

23. The apparatus of claim 22, wherein the search engine component or the friends bias component is further operable to remove a portion of the search result that was previously provided to a predetermined user collaborating with the user who initiated the query.

24. A method for obtaining search results, comprising:
receiving a query initiated by a user;
forwarding the query for performance of a search; and
receiving and storing a biased search result in response to the query, wherein the biased search result is based on friends bias data.

25. The method of claim 24, further comprising receiving a friend identification corresponding to the query, wherein the friend identification is operable to determine the friend bias data.

26. The method of claim 25, further comprising forwarding contact information from a contact list stored in an access terminal associated with the user to a friends bias component, wherein the contact list comprises the friend identification.

27. The method of claim 24, further comprising prompting the user to enter feedback associated with the biased search result, receiving user feedback associated with the biased search result, and forwarding the user feedback for updating a friends database based on the user feedback.

28. The method of claim 24, wherein receiving the biased search result further comprises at least one of receiving a search result filtered based on the friends bias, receiving a search result ranked based on the friends bias, or receiving a search result filtered and ranked based on the friends bias.

29. The method of claim 24, wherein receiving the biased search result further comprises at least one of receiving a search result biased according to information associated with activities of at least one of the user or friends identified by the user.

30. The method of claim 24, further comprising obtaining enhancement data corresponding to the query, and wherein receiving the biased search result further comprises receiving a search result further based on the enhancement data.

31. The method of claim 24, wherein receiving the biased search result further comprises receiving a search result further based on at least one of including or excluding information based on the friends bias.

32. The method of claim 31, wherein receiving the biased search result based on excluding information further comprises removing a portion of the search result that was previously provided to a predetermined user collaborating with the user who initiated the query.

33. A computer program product configured to obtain search results, comprising:
a computer readable medium, comprising:
at least one instruction for causing a computer to receive a query initiated by a user;
at least one instruction for causing the computer to forward the query for performance of a search; and
at least one instruction for causing the computer to receive and store a biased search result in response to the query, wherein the biased search result is based on friends bias data.

34. At least one processor configured to obtain search results, comprising:
a first module for receiving a query initiated by a user;
a second module for forwarding the query for performance of a search; and
a third module for receiving and storing a biased search result in response to the query, wherein the biased search result is based on friends bias data.

35. An apparatus for obtaining search results, comprising:
means for receiving a query initiated by a user;
means for forwarding the query for performance of a search; and
means for receiving and means for storing a biased search result in response to the query, wherein the biased search result is based on friends bias data.

36. An apparatus for obtaining search results, comprising:
a search initiator component operable to receive a query initiated by a user;
a communications component operable to forward the query for performance of a search; and
a search result review component operable to receive and store a biased search result in response to the query, wherein the biased search result is based on friends bias data.

37. The apparatus of claim 36, wherein the search initiator component is further operable to receive a friend identification corresponding to the query, wherein the friend identification is operable to determine the friend bias data.

38. The apparatus of claim 37, wherein the communications component is further operable to forward contact information from a contact list stored in the apparatus to a friends bias component, wherein the contact list comprises the friend identification.

39. The apparatus of claim 36, further comprising a bias identification component operable to prompt the user to enter feedback associated with the biased search result, and to receive user feedback associated with the biased search result, and wherein the communications component is further operable to forward the user feedback for updating a friends database based on the user feedback.

40. The apparatus of claim 36, wherein the biased search result further comprises at least one of a search result filtered based on the friends bias, a search result ranked based on the friends bias, or a search result filtered and ranked based on the friends bias.

41. The apparatus of claim 36, wherein receiving the biased search result further comprises at least one of receiving a search result biased according to information associated with activities of at least one of the user or friends identified by the user.

42. The apparatus of claim 36, wherein the search initiator component is further operable to obtain enhancement data corresponding to the query, and the biased search result further comprises a search result further based on the enhancement data.

43. The apparatus of claim 36, wherein the biased search result further comprises a search result further based on at least one of including or excluding information based on the friends bias.

44. The apparatus of claim 43, wherein the biased search result based on excluding information further excludes a portion of the search result that was previously provided to a predetermined user collaborating with the user who initiated the query.
